(19) United States
(12) Patent Application Publication
(10) Pub. No.: US 2008/0153429 A1
(43) Pub. Date: Jun. 26, 2008

(54) Network Managed Compressed Mode Operation

(75) Inventors: Phillip Marc Johnson, Raleigh, NC (US); Ramanathan Asokan, Cary, NC (US); William O. Camp, Chapel Hill, NC (US)

Correspondence Address: COATS & BENNETT/SONY ERICSSON, 1400 CRESCENT GREEN, SUITE 300, CARY, NC, 27511, US

(73) Assignee: SONY ERICSSON MOBILE COMMUNICATIONS AB, Lund (SE)

(21) Appl. No.: 11/615,326

(22) Filed: Dec. 22, 2006

(51) Int. Cl. H04B 1/00

(52) U.S. Cl. 455/72

(57) ABSTRACT

A base station monitors the uplink load and sends control signals to one or more mobile terminals to selectively enable and disable compressed mode operation. The base station can divide the mobile terminals into groups and can assign different compressed mode patterns to different groups of mobile terminals so that the transmissions from mobile terminals in different groups while in compressed mode are not synchronized. If load imbalances occur, the network can reassign mobile terminals from one group to another.

### BACKGROUND

The present invention relates generally to compressed mode operation in a mobile communication system, and more particularly, to methods of controlling compressed mode operation by a plurality of mobile terminals.

A known problem with WCDMA phones is excessive power consumption that results in undesirable current drain and short battery life. When engaged in normal voice communications, a WCDMA phone transmits and receives continuously. This continuous operation is one of the primary reasons for the undesirable current drain in WCDMA phones. Another reason for current drain is the presence of a duplexer in the transmit path that increases path loss.

U.S. patent application Ser. No. 11/614,488 describes a method of reducing power consumption in a WCDMA phone by allowing the mobile terminals to switch to a compressed mode of operation. In the compressed mode, the mobile terminals transmit intermittently with a desired duty factor rather than continuously and increase their transmit power during the “on” periods to maintain the same data rate. Problems may arise with compressed mode operation if a significant number of users operate in a compressed mode at the same time. Because the mobile terminals normally increase their transmit power in compressed mode, they will interfere with other users if too many mobile terminals transmit at the same time in the compressed mode. Further, too many mobile terminals switching their transmitters on and off at the same time may result in undesirably large swings in the uplink load.

### SUMMARY

The present invention provides network-based methods to network manage compressed mode operation by a plurality of mobile terminals to distribute the uplink load resulting from compressed mode operation over time and to thereby reduce overall interference in the system resulting from compressed mode operation. Various methods are described with the same goal of avoiding synchronized transmissions of too many mobile terminals while in compressed mode. The base station or network monitors the uplink load and sends control signals to one or more mobile terminals to selectively enable and disable compressed mode operation. The base station can divide the mobile terminals into groups and can assign different compressed mode patterns to different groups of mobile terminals so that the transmissions from mobile terminals in different groups while in compressed mode are not synchronized. If load fluctuations occur, the network can reassign mobile terminals from one group to another to redistribute the load versus time.

### BRIEF DESCRIPTION OF THE DRAWINGS

FIG. 1 is a schematic diagram of a communication system.

FIG. 2 is a flow chart illustrating a method implemented at a base station to selectively enable and disable compressed mode operation.

FIG. 3 illustrates an exemplary set of compression patterns with a 50% duty factor for compressed mode operation.

FIG. 4 illustrates an exemplary set of compression patterns with different duty factors for compressed mode operation.

FIG. 5A illustrates an exemplary method for assigning mobile terminals to different compressed mode groups.

FIG. 5B illustrates an exemplary method for deleting mobile terminals from compressed mode groups.

FIG. 6 illustrates an exemplary method for dynamically reassigning mobile terminals from one compressed mode group to another.

FIG. 7 illustrates an exemplary base station for implementing compressed mode.

### DETAILED DESCRIPTION

The present invention provides a method of reducing power consumption in a radio communication system. The present invention is described herein in the context of a WCDMA radio communication system, though the techniques can be applied in other radio communication systems. Further, this application explains how the principles of the present invention can be applied to a voice channel in a WCDMA system. However, the principles described herein can be applied to other types of information, such as audio, video, and other data.

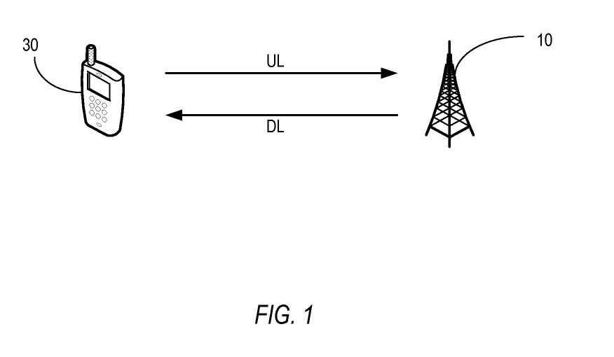

FIG. 1 illustrates communications between a base station 10 in a mobile communication system and a mobile terminal 30. The base station 10 transmits voice to the mobile terminal 30 over a downlink channel (DL). The mobile terminal 30 transmits voice to the base station 10 over an uplink channel (UL). The voice channels may be circuit-switched or packet-switched channels. For normal voice communications, the transmitter and receiver of the mobile terminal 30 are turned on continuously. The “always on” characteristic of voice communications in WCDMA systems results in excessive drain on battery power of the mobile terminal 10.

U.S. patent application Ser. No. 11/614,488 titled COMPRESSED MODE FOR REDUCING POWER CONSUMPTION filed Dec. 21, 2006 describes a method of reducing power consumption a WCDMA phone by allowing the mobile terminals 30 to switch to a compressed mode of operation. In the compressed mode, the mobile terminals 30 transmit intermittently with a desired duty factor rather than continuously, and increase their transmit power during the “on” periods to maintain the same data rate. This application is incorporated herein in its entirety by reference. To briefly summarize, the base station 10 continuously monitors the uplink load and sends control signals to one or more mobile terminals 30 to selectively enable and disable compressed mode operation depending on the uplink load. In general, compressed operation is enabled when the base station 10 has excess capacity on the uplink given the current loading conditions. If the uplink is heavily loaded, compressed mode is disabled. When the compressed mode is enabled, the mobile terminals 30 individually switch between the compressed mode (e.g. intermittent transmission) and normal mode (e.g., continuous transmission) on the uplink depending on the current transmit power level of the mobile terminal 30. When the current transmit power of the mobile terminal 30 is low and the mobile terminal 30 has sufficient power headroom, it uses compressed mode for uplink communications. Otherwise, the mobile terminal 30 transmits in normal mode on the uplink.

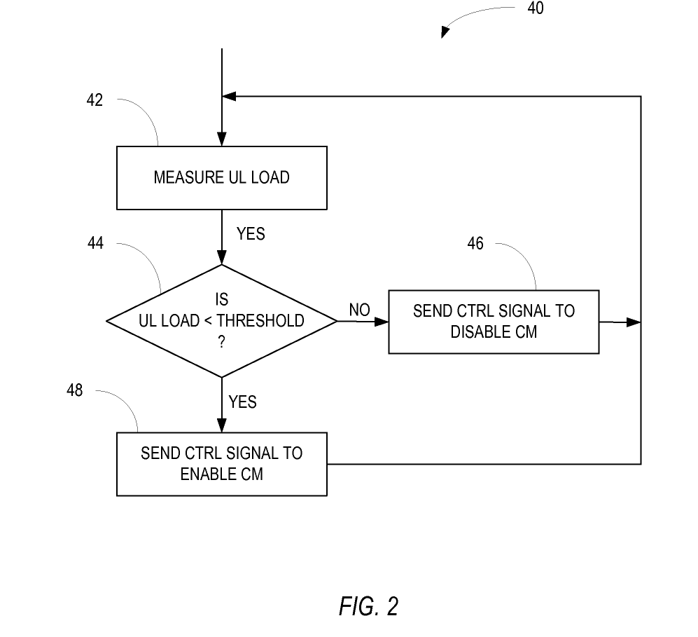

FIG. 2 illustrates an exemplary method 40 repeated periodically by a base station 10 to selectively enable and disable compressed mode operation by mobile terminals 30. The base station 10 periodically determines the uplink load (block 42) and compares the measured load to a threshold (block 44). The base station 10 may use Rise Over Thermal (ROT), which is a ratio between a total power received at the base station 10 and the thermal noise, as a measure of the uplink load. Alternatively, the base station 10 may determine its uplink load by calculating the total power received at the base station 10, or by determining the number of mobile terminals 30 it currently serves over the uplink and multiplying the total number by an average received power for the mobile terminals 30. If the uplink load is below the threshold, the base station 10 sends a control signal to one or more mobile terminals 30 to enable compressed mode operation (block 48). The base station 10 may enable compressed mode for all mobile terminals 30 or for a specific group of mobile terminals 30. The control signal may be sent, for example, over a common downlink control channel to all mobile terminals 30 or to a specific group of mobile terminals 30. If the uplink load is greater than or equal to the threshold, the base station 10 sends a control signal to one or more mobile terminals 30 to disable compressed mode operation (block 46). Again, the base station 10 may disable compressed mode for all mobile terminals 30 or for a specific group of mobile terminals 30.

Problems may arise with compressed mode operation if a significant number of mobile terminals 30 operate in a compressed mode at the same time. Because the mobile terminals 30 normally increase their transmit power in compressed mode, they will interfere with other users if too many mobile terminals 30 transmit at the same time in the compressed mode. Moreover, if a large number of mobile terminals 30 switch their transmitters on and off at the same time, there will be pronounced swings in uplink load versus time.

The mobile terminals 30 may be allowed to randomly select slots in a defined transmission period to use for transmission in the compressed mode so that the transmissions from mobile terminals 30 operating in the compressed mode do not occur simultaneously. For example, each mobile terminal 30 may randomly select one or more compressed mode slots in the defined transmission period using the mobile terminal serial number as a seed to generate a random number. As used herein, the term compressed mode slot refers to slots in a defined transmission period when the mobile terminal 30 is transmitting. Other seed values could also be used as long as the seed value is not the same for a large number of mobile terminals 30. Random selection of compressed mode slots, however, is not the most effective method and may still result in undesirably high and uneven instantaneous loads.

According to the present invention, the base station 10 or other network node manages compressed mode operation by a plurality of mobile terminals 30 by assigning different compression patterns to different mobile terminals 30 or groups of mobile terminals 30. The compression pattern is an on/off pattern at the granularity of one slot that is used by the mobile terminals 30 while in compressed mode. The compression pattern may be designated by a sequence of binary values. For example, the pattern 1001 is a four slot pattern indicating that the mobile terminal 30 should transmit in slots 1 and 4 and turn off its transmitter in slots 2 and 3. The compression patterns may be designed such that the intermittent transmissions by the mobile terminals 30 are not all synchronized and are spread in time. Further, the compression patterns may be designed to avoid the simultaneous switching of transmitters on and off by too many mobile terminals 30, thereby avoiding large swings in uplink load versus time.

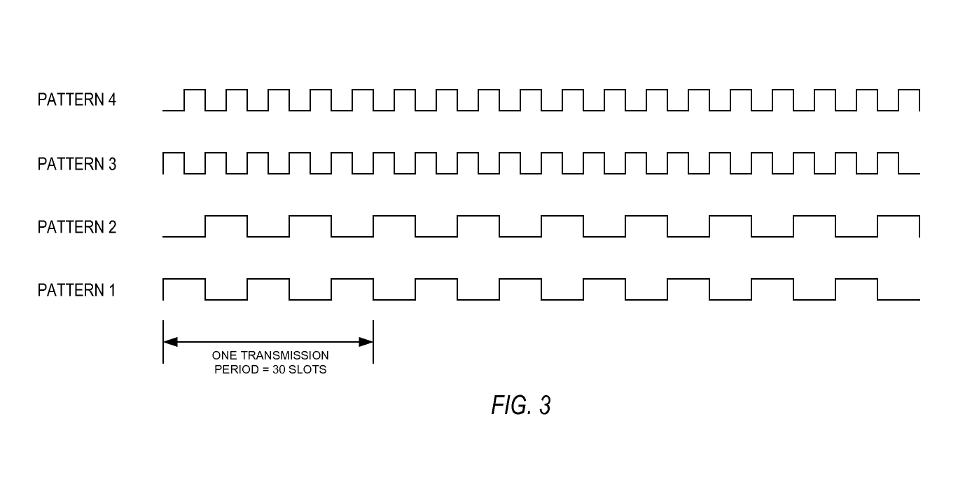

FIG. 3 illustrates an exemplary set of compressed mode patterns with a 50% duty factor. In this case, there are four distinct periodic patterns, which may be assigned to four different groups of mobile terminals 30. Pattern 1 is represented by the sequence 111111000000111111000000111111, which inverts and repeats during every transmission period. Pattern 2 is represented by the sequence 111000111000111000111000111000111000, which repeats every transmission period. Patterns 3 and 4 are the complements of patterns 1 and 2 respectively. All four compression patterns have a 50% duty factor, which can be denoted as a ½ compression pattern. If the compression patterns shown in FIG. 3 are assigned to four different groups of mobile terminals 30 and the groups are of equal size, one half of the mobile terminals 30 in compressed mode will be turning their transmitters on and the other half will be turning their transmitters off. Thus, any changes in the uplink mode should be due primarily to changes in channel conditions and in the number of mobile terminals being served at a given time.

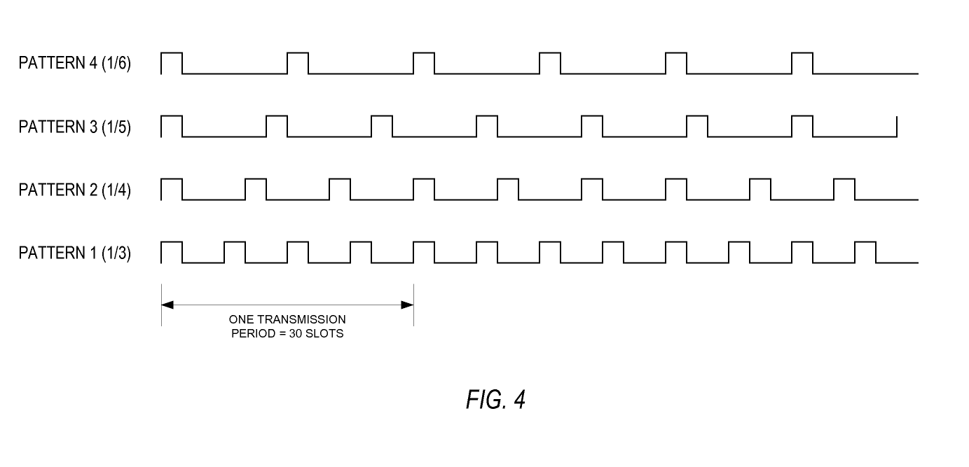

In some embodiments of the invention, compression patterns with different duty cycles may be assigned to different groups of mobile terminals 30. This approach is illustrated in FIG. 4. FIG. 4 shows four compression patterns with different duty cycles. The compression patterns may be assigned to groups of mobile terminals 30 in such a manner that no two groups have compression patterns with the same duty factor. In this example, the ¼ and ⅙ compression patterns may be assigned to mobile terminals in a first group (e.g., group A), and the ⅓ and ⅕ compression patterns may be assigned to a different group (e.g., group B). It will be noted that some of the compression patterns in this example do not repeat in every transmission period. That is, the repetition period is different for the different compression patterns in this example.

In one exemplary embodiment, the mobile terminals 30 are divided into groups and different sets of compression patterns are assigned to each group. Each group is assigned a set of compression patterns with different duty factors (e.g., 25%, 50%, 75%, etc.) that it may use for compressed mode operation. The compression patterns assigned to a particular group are not assigned to any other group. Thus, the compression patterns assigned to a particular group of mobile terminals 30 are unique to that group. As new mobile terminals establish calls, they are added to a group. When a mobile terminal 30 terminates a call, it is dropped from its group.

In compressed mode operation, the mobile terminals 30 select one of the compression patterns assigned to its group, depending on its power headroom. As new mobile terminals establish calls, they are added to a group. A mobile terminal 30 with limited power availability may select a compression pattern with a high duty factor (e.g., 80%), while another mobile terminal 30 with more power headroom may select a compression pattern with a small duty factor (e.g., 25%). The available duty factors and corresponding compression patterns can be predefined and stored in memory at the mobile terminal 30. When a mobile terminal 30 switches into a compressed mode, it selects a desired duty factor and a corresponding compression pattern from the available compression patterns.

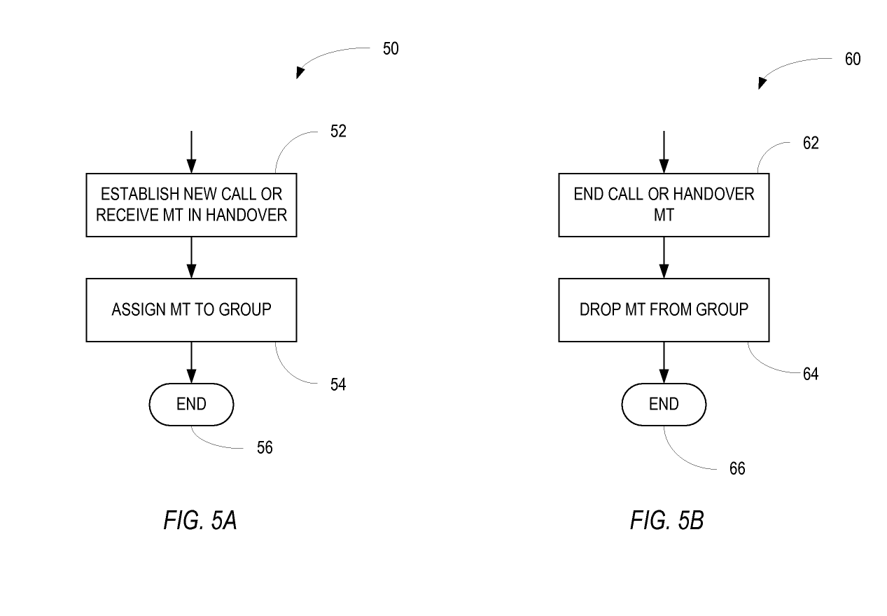

FIGS. 5A and 5B illustrate exemplary procedures performed by a base station 10 for managing compressed mode groups. FIG. 5A illustrates a procedure 50 executed during call set up. When a call is set up or when a mobile terminal 30 is received in handover (block 52), the base station 10 assigns the mobile terminal 30 to a specified group (block 54). The base station 10 may keep track of the number of mobile terminals 30 assigned to each group and make assignments as necessary in order to keep the groups nearly equal in size. Alternatively, the base station 10 may monitor the total load attributable to each group and make assignments as necessary in order to maintain the total loads as even as possible. The procedure ends after the assignment is made (block 56). FIG. 5B illustrates a complementary procedure 60 for removing mobile terminals 30 from groups. When a call ends or a mobile terminal 30 is released in a handover (block 62), the base station 10 drops the mobile terminal 30 from the compressed mode group (block 64) and the procedure ends (block 66).

There may be circumstances where usage patterns or other conditions outside the control of the base station 10 result in an undesirable variation in the uplink load. Variation in uplink load may be caused, for example, by variation in call duration for mobile terminals 30 in different groups and variation in the duty factors applied by mobile terminals 30 in different groups. Such variations may cause undesirably large fluctuations in uplink load. According to the present invention, the base station 10 may dynamically reassign mobile terminals 30 from one group to another to minimize fluctuations in uplink load versus time.

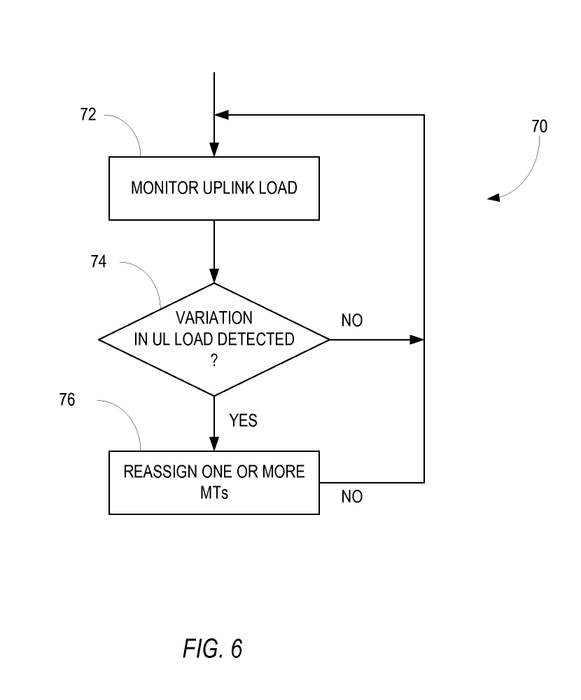

FIG. 6 illustrates an exemplary method 70 performed by the base station 10 to minimize fluctuations in uplink load. The base station 10 continuously monitors the uplink load and checks for large variations in the uplink load over time (block 72). If the base station 10 detects undesriably large variation in the uplink load (block 74), it may reassign mobile terminals 30 from one group to a new group (block 76). In this manner, fluctuations in the uplink load can be reduced or minimized.

A further means to control the timing of uplink transmissions from the mobile terminals 30 can make use of all the previous methods, but instead of controlling the mobile terminal's uplink compressed mode pattern directly through a downlink control channel, may instead directly control the timing of the downlink compressed mode pattern. In this case, the mobile terminal 30 may select an uplink compressed mode timing with a fixed timing relationship to the downlink compressed mode timing. This method assumes that there is a downlink compressed mode being used along with an uplink compressed mode. Both uplink and downlink compressed modes do not have to have the same duty factor for this method of control to be effective. There only needs to be a known relationship between the timing of the uplink and downlink compressed modes in order for the base station 10 to be able to spread the uplink load versus time by means of controlling the downlink compressed mode timing to the plurality of mobile terminals 30.

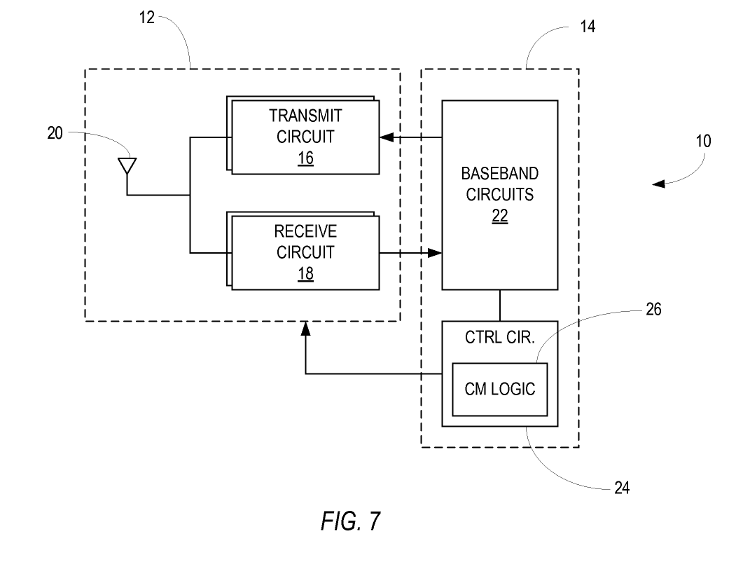

FIG. 7 illustrates an exemplary base station 10 according to one exemplary embodiment. The base station 10 comprises a radio frequency section 12 and a digital section 14. The radio frequency section 12 comprises a transmit circuit 16, a receiver circuit 18, and a shared antenna 20. While only one transmit circuit 16 and receive circuit 18 is shown, those skilled in the art will appreciate that a base station 10 will typically include an array of transmit and receive circuits 16, 18 that it can allocate to different mobile terminals 30. The transmit circuit 16 upconverts, filters, and amplifies signals output by the digital section 14 for transmission via antenna 20. A D-to-A converter (not shown) converts signals output to the transmit circuit 16. Receive circuit 18 downconverts the receive signals to baseband frequency, and then filters and amplifies the received signal. An A-to-D converter (not shown) converts the receive signal to digital form for processing in digital section 14.

The digital section 14 comprises baseband circuits 22 and a control circuit 24. The baseband circuits 22 and control circuit 24 may comprise one or more processors or processing circuits. The baseband circuit 22 processes signals transmitted and received by the base station 10. The baseband circuit 22 encode, modulate, and spread transmitted signals. On the receiver side, the baseband circuits 22 despread, demodulate, and decode received signals. The baseband circuit 122 also implements a vocoder (not shown) for encoding and decoding speech signals.

The control circuit 24 controls the overall operation of the base station 10. The control circuit 24 includes compression mode (CM) logic 26 for managing compressed mode operation as described herein. The CM mode control logic 26 selectively enables and disables compressed mode on the uplink and assigns mobile terminals 30 assigns mobile terminals 30 to groups.

The present invention provides a method and apparatus for substantially reducing power consumption in a WCDMA terminal. The present invention may be applied to either a mobile terminal or base station. When applied to a mobile terminal, the present invention results in longer battery life and talk times. The present invention is also beneficial in reducing overall interference in the network.

The present invention may, of course, be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

1. A method of reducing power consumption in a mobile communication system, said method comprising:
determining uplink load at a base station; and
sending a control signal to selectively enable one or more mobile terminals to operate in a compressed mode for uplink transmission based on said uplink load.

2. The method of claim 1 further comprising assigning respective compression patterns to said mobile terminals for use in said compressed modes to reduce overlapping transmissions by said mobile terminals in compressed mode.

3. The method of claim 2 wherein assigning respective compression patterns to said mobile terminals comprises dividing said mobile terminals into groups and assigning one or more compression patterns to each group.

4. The method of claim 3 wherein assigning one or more compression patterns to each group comprises assigning each group a set of compression patterns with different duty cycles.

5. The method of claim 2 wherein assigning respective compression patterns to said mobile terminals for use is said compressed mode comprises assigning compressed patterns to said mobile terminals during call set up.

6. The method of claim 2 wherein assigning respective compression patterns to said mobile terminals for use is said compressed mode comprises assigning compressed patterns to said mobile terminals following a handover.

7. A base station comprising:
a transceiver for communicating with a plurality of mobile terminals over an uplink channel;
a control circuit to monitor the uplink load and to selectively enable and disable a compressed mode operation on said uplink channel by one or more mobile terminals based on the uplink load.

8. The base station of claim 7 wherein the base station selectively enables and disables compressed mode for uplink communications by sending control signals to one or more mobile terminals.

9. The base station of claim 8 wherein said control circuit is configured to assign respective compression patterns to said mobile terminals for use in said compressed modes to reduce overlapping transmissions by said mobile terminals in said compressed mode.

10. The method of claim 9 wherein said control circuit assigns respective compression patterns to said mobile terminals by dividing said mobile terminals into groups and assigning one or more compression patterns to each group.

11. The base station of claim 10 wherein said control circuit assigns each group a set of compression patterns with different duty cycles.

12. The base station of claim 9 wherein said control unit is configured to assign respective compression patterns to said mobile terminals during call set up.

13. The base station of claim 9 wherein said control unit is configured to assign respective compression patterns to said mobile terminals following a handover.
